(19) United States
(12) Patent Application Publication
(10) Pub. No.: US 2010/0135179 A1
(43) Pub. Date: Jun. 3, 2010

(54) COMMUNICATION DEVICE

(75) Inventors: Daniel Bauer, Birmensdorf (CH); Luis Garces-Erice, Zurich (CH); John G. Rooney, Sebastien (FR); Paolo Scotton, Horgen (CH)

Correspondence Address: IBM CORPORATION, T.J. WATSON RESEARCH CENTER, P.O. BOX 218, YORKTOWN HEIGHTS, NY, 10598, US

(73) Assignee: INTERNATIONAL BUSINESS MACHINES CORPORATION, Armonk, NY (US)

(21) Appl. No.: 12/624,456

(22) Filed: Nov. 24, 2009

(30) Foreign Application Priority Data
Nov. 28, 2008 (EP) 08105892.7

(51) Int. Cl. H04L 12/26

(52) U.S. Cl. 370/252

(57) ABSTRACT

A communication device, a computer program product, and a method for operating a communication device. The communication device has at least one protocol stack having at least two protocol modules, a number of threads for executing the protocol modules, the respective thread being blocked or active, the respective active thread being idle or busy, and a control unit having first means adapted to adjust the number of active threads by monitoring a ratio between a first time duration the active threads are busy and a second time duration the active threads are idle.

### CROSS REFERENCE TO RELATED APPLICATION

This application claims priority under 35 U.S.C. 119 from European Patent Application 08105892.7, filed Nov. 28, 2008, the entire contents of which are incorporated herein by reference.

### BACKGROUND OF THE INVENTION

1. Field of the Invention

The present invention relates to a communication device, and more particularly to a communication device with improved operation.

2. Description of Related Art

A communication device or communication sub-system may include one or more communication stacks or protocol stacks. Such a protocol stack may consist of a set of distinct protocol modules layered on top of each other. Such a protocol module may be responsible for some distinct part of the communication. In this regard, the communication device may be connected to other communication devices or units.

For example, when a messaging protocol is run over TCP/IP, the IP-layer is responsible for formatting data into packets and for routing those packets and across the network, the TCP-layer is responsible for reliable delivery of those packets even when the network layer may lose them. The TCP-layer, TCP-module, IP-layer and IP-module are typical protocol modules. The messaging layer or messaging protocol may be responsible for supporting the publish/subscribed abstraction over multiple TCP connections.

For a person skilled in the art, the IP-protocol suit is a well known set of protocol stacks, e.g. RTP/UDP/IP, TCP/IP, etc. The protocol stacks may be built over IP that are an integral part of widely available operating systems with network capabilities such as Windows and Linux. While the code for these protocol stacks may be structured as layers or modules, in general the thread of control unit that initiates transmission or reception executes the code present at the respective layer or protocol module, i.e. the separation in code division is not reflected in the mode of execution. This is an efficient way of executing the small account of instructions required to perform the protocol logic on machines with smaller number of processors as the computation cost of switching between threads is high.

In consequence, these stacks or protocol stacks may be structured such that threads of execution may run to completion or until they block.

Furthermore, additional protocol layers are possible that support publish/subscribe, queuing abstraction, mediation and/or security functions. The number of instructions required to execute these functions is in general higher than that of the lower layers or protocol modules in the protocol stack. For example, encryption is computationally intensive and mediating functions may involve applying complex XML specific logic, which combines multiple messages together.

In this regard, the protocol stack may include a number of protocol modules as mentioned above. Further, a thread pool may be provided for executing the protocol modules, the thread pool including a number of threads.

A challenge is to find the number of threads that should be concurrently executed. A general solution cannot be given because it depends on the nature and depth of the protocol stacks, the ratio of I/O to CPU related tasks, and the other activities running on a machine, e.g. the applications making use of the messaging system or communication device.

Accordingly, it is an aspect of the present invention to improve the performance of a communication device.

### SUMMARY OF THE INVENTION

According to a first aspect of the present invention, a communication device for executing a number of threads for executing protocol modules includes: at least one protocol stack having at least two protocol modules, wherein (i) the threads are blocked or active and (ii) the active thread are idle or busy; and a control unit having and element configured to adjust the number of active threads by monitoring a ratio between a first time duration during which the active threads are busy and a second time duration during which the active threads are idle.

According to another aspect of the present invention, a method for operating a communication device includes the steps of: providing at least one protocol stack having at least two protocol modules; providing a number of threads for executing the protocol modules, each thread being blocked or active, each active thread being idle or busy; monitoring a ratio between a first time duration during which the active threads are busy and a second time duration during which the active threads are idle; and adjusting the number of active threads dependent on the monitoring of the ratio.

A further aspect of the invention is a computer readable medium tangibly embodying a computer readable program which, executed on a computer, causes the computer to: provide at least one protocol stack having at least two protocol modules; provide a number of threads for executing the protocol modules, the respective thread being blocked or active, the respective active thread being idle or busy; monitor a ratio between a first time duration during which the active threads are busy and a second time duration during which the active threads are idle; and adjust the number of active threads in dependence on the monitoring of the ratio.

### BRIEF DESCRIPTION OF THE FIGURES

FIG. 1 shows a first embodiment of the communication device of the present invention;

FIG. 2 shows a second embodiment of the communication device of the present invention;

FIG. 3 shows a third embodiment of the communication device of the present invention;

FIG. 4 shows a fourth embodiment of the communication device of the present invention;

FIG. 5 shows a first embodiment of a sequence of method steps for operating a communication device of the present invention; and

FIG. 6 shows a second embodiment of a sequence of method steps for operating a communication device of the present invention.

Like or functionally-like elements in the Figures have been allotted the same reference signs if not otherwise indicated.

### DETAILED DESCRIPTION OF PREFERRED EMBODIMENTS

The performance of a communication device may be improved by adjusting the number of active threads, preferably to an optimal number, by monitoring a ratio between a first time duration in which the active threads are busy and a second time duration in which the active threads are idle. If the aggregate ratio is too high, e.g. lies over predefined upper threshold, then additional threads may be added to the system up to a predefined maximum, i.e. these threads become active. In contrast, if the ratio is too low, e.g. lies under predefined lower threshold, then threads may be removed from the system assuming that there is at least one left. The length of time across which the threads are monitored or observed, may be called monitoring duration or epoch.

If the ratio lies over the upper threshold value, the communication device may be considered to be overloaded. In contrast, if the ratio lies under the lower threshold value, the communication device may be considered to be under-loaded.

If the upper and the lower threshold values are too close to each other, the system may oscillate. In this regard, better or optimal values for the epoch and the upper and lower threshold values may be obtained from analyses or testing the expected range of operation of the system or communication device.

A protocol stack may consist of one or more protocol modules, i.e. a stack or deck of individual protocol functions. As such, protocol stack is a description containing the sequence of modules that make up the stack. A protocol module is an implementation of a protocol function, for example an encryption/decryption function.

Before the communication device or execution environment can execute the protocol stack, it may be instantiated. A protocol stack may be instantiated by instantiating each of the protocol modules in the stack as follows:

First, the execution environment reserves memory for each protocol module. Second, each protocol module initializes its internal state using the memory set aside for it. Third, the execution environment links the protocol modules in the protocol stack such that each protocol module is aware of the protocol module directed above and directed below in the protocol stack. This linking mechanism may enable each protocol module to pass events up and down the protocol stack.

The execution environment or communication device may instantiate a protocol stack on two occasions: first, in order to initiate a communication session to an external entity or external communication unit, and second, in order to accept a communication session from an external entity or external unit. Thus, an instantiated protocol stack may exist for every communication session.

The data exchanged within a session is also referred to as event flow or message flow. An individual flow may be processed by one instantiated protocol stack. The execution environment and communication device may use an event-passing mechanism to execute the protocol stacks.

At the core of the execution environment or communication device may be a thread pool containing the set of threads and a control unit or dispatcher that associates the threads with protocol modules for processing the events. E.g. the dispatcher may include the control unit and at least one event queue. An event buffered in such an event queue may have a header, that among other functions identifies the protocol module where it should be processed, and data. A typical event may be the arrival of a packet from the network. After an event occurs it is put into the dispatcher's event queue. The dispatcher constantly may choose the next event to process, a on-used thread in the thread pool and the protocol module that should handle the event.

The high-level algorithm for the dispatcher may be as follows:

First, a thread is no longer busy and asks the dispatcher or control unit for work. Second, the dispatcher picks the next event from the event queue which is to be served. If there are multiple event queues, it picks an event queue from the first non-empty event queue that has the highest priority. Third, based one the event's header, the dispatcher or control unit may identify the protocol module and instructs the executed protocol function on the event.

In one embodiment of the communication device, the first means of the control unit is adapted to increase the number of active threads if the ratio between the first time duration and the second time duration lies over a predefined upper threshold.

In a further embodiment of the communication device, the first means of the control unit are adapted to decrease the number of active threads if the ratio between the first time duration and the second time duration lies under a predefined lower threshold.

In a further embodiment of the communication device, the communication device includes a number of event queues, the respective event queue adapted to buffer at least one event.

In a further embodiment of the communication device, the control unit further includes second means, the second means adapted to dispatch a definite number of the events of a served event queue to corresponding definite protocol modules in the corresponding protocol stack for executing the definite protocol modules by a corresponding number of active threads such that the definite number of the events within the same protocol stack may be processed in parallel in a pipeline fashion.

As a result, a type of assembly line or pipe line is created in which multiple messages in the same flow, but in different protocol modules in the protocol stack at any given time, may be processed simultaneously by different threads of the thread pool. The control unit may guaranty in this regard that only a single event is processed by a given protocol module at a given point of time. This in turn may guaranty in-order delivery, advantageously. Therefore, parallelism may be provided within the protocol stack to allow multiple different messages within the same flow to be processed.

In a further embodiment of the communication device, each active thread of the corresponding number of active threads executes the respective protocol module with the respective dispatched event within a defined clock cycle.

In a further embodiment of the communication device, the control unit further includes third means adapted to decide which event queue is to be served by the protocol modules and the active threads.

In a further embodiment of the communication device, the number of event queues includes event queues with different priorities.

In a further embodiment of the communication device, the third means of the control unit are adapted to ensure that an event queue with a higher priority is buffers no event before dispatching an event from an event queue with a lower priority.

Different types of events may have different priorities, for example timing events may have higher priority than data events. This is taken into account within the control unit by having distinct event queues with different priorities and ensuring all higher priorities queues are empty before taking any event from a lower priority event queue.

In a further embodiment of the communication device, the control unit further includes fourth means, the fourth means adapted to provide a monitoring result after a respective monitoring duration by monitoring the ratio between the first time duration and the second time duration.

In a further embodiment of the communication device, the first means is adapted to adjust the number of active threads dependent on the monitoring result provided by the fourth means after every monitoring duration.

In a further embodiment of the communication device, the monitoring duration is between 30 ms and 300 ms, in particular between 100 ms and 200 ms.

In a further embodiment of the communication device, the upper threshold lies between 0.7 and 0.9.

In a further embodiment of the communication device, the lower threshold lies between 0.1 and 0.3.

In a further embodiment of the communication device, a dispatcher is provided, the dispatcher including the control unit and the event queue.

In a further embodiment of the communication device, an event has data and a header indicating a protocol module by which the event has to be processed.

In a further embodiment of the communication device, the communication device includes a plurality of protocol stacks, each protocol stack is connected to a single connection outside the communication device.

In a further embodiment of the communication device, the respective protocol module is adapted to generate an event and to write back the generated event to the event queue.

The respective protocol module may generate events and write those back into the respective event queue. This is the only interaction of the protocol modules with the rest of the protocol stack. Each protocol module in a protocol stack may be adapted to have information regarding the name of the protocol module above and below it. A protocol module forwarding a message up to the protocol stack may write an event containing the message data and with the destination of the protocol module above it. A protocol module sending a message down the protocol stack may do the same but the destination will be the protocol module below it. The passage of a message through the protocol stack may be seen as a series of interactions between the protocol modules and the control unit.

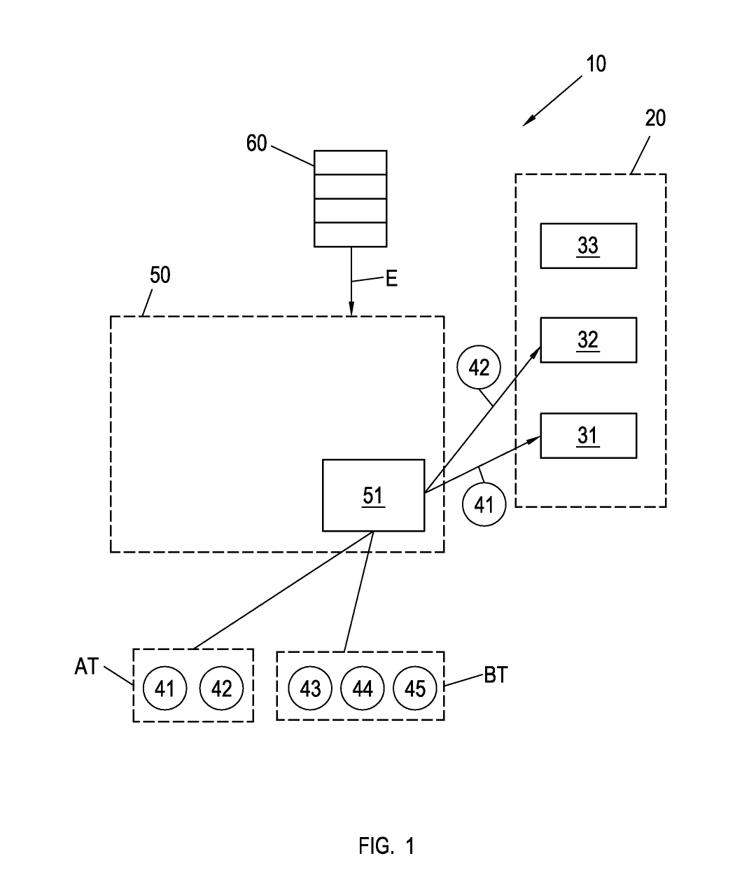

FIG. 1 shows a first embodiment of a communication device 10. The communication device includes at least one protocol stack 20, a number of threads 41-45 and a control unit 50. Further, the communication device 10 may include an event queue 60 adapted to buffer events E. The event queue 60 may be integrated to the control device or control unit 50 or may be external to the control device 50, alternatively.

As mentioned above, the communication device 10 may include a number of event queues 60, the respective event queue 60 adapted to buffer at least one event E. An event E has data and a header indication a protocol module 31-33 by which it has to be processed.

Without loss of generality, FIG. 1 shows only one protocol stack 20. The protocol stack 20 includes at least two protocol modules 31-33. According to the example of FIG. 1, the protocol stack 20 has a first protocol module 31, a second protocol module 32 and a third protocol module 33.

For example, the first protocol module 31 may be a deframer, the second protocol module 32 may be an en-/decryption module and the third protocol module 33 may be a messaging/transformation module.

The number of threads 41-45 is adapted to execute the protocol modules 31-33, the respective thread 41-45 being blocked or active, the respective active thread 41, 42 being idle or busy.

In this regard, the threads 41-45 are separated to active threads AT with the threads 41 and 42 and to blocked threads BT with the threads 43 to 45 for illustration. The threads 41-45 may be arranged in a thread pool.

The control unit 50 includes first means 51. The first means 51 may be adapted to adjust the number of active threads 41, 42 by monitoring a ratio R between a first time duration T1, the active threads 41, 42 are busy, and a second time duration T2, the active threads 41, 42 are idle.

The ratio R may be computed by the following formula:

$$R = \frac{T 1}{T 1 + T 2}$$

By means of above formula, the first means 51 of the control unit 50 may be adapted to increase the number of active threads 41, 42 if the ratio R between the first time duration T1 and the second time duration T2 is above a predefined upper threshold U, where

(R>U).

In an analogous way, the first means 51 of the control unit 50 may be adapted to decrease the number of active threads 41, 42, if the ratio R between the first time duration T1 and the second time duration T2 lies under predefined lower threshold L (R<L).

In this regard, the upper threshold U may be between 0.7 and 0.9 and the lower threshold L may be between 0.1 and 0.3.

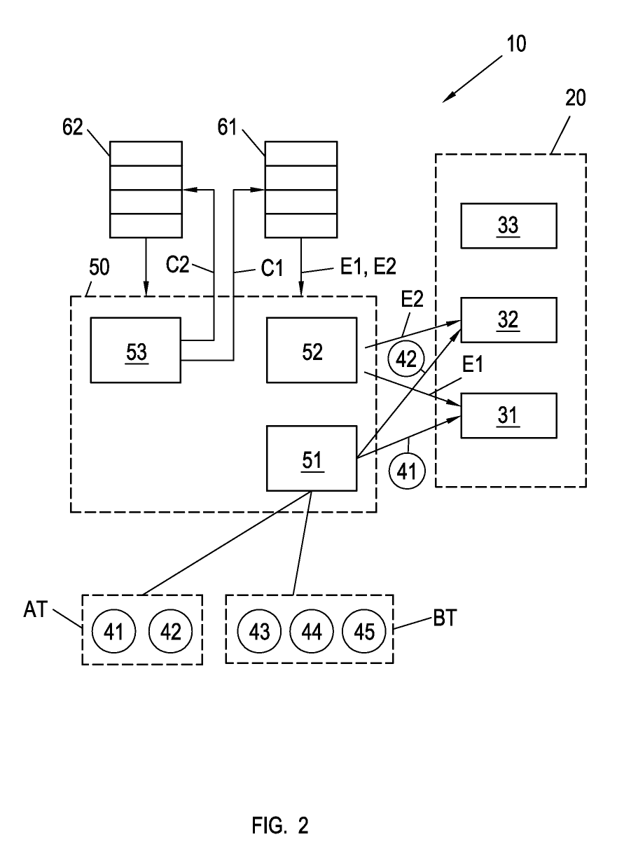

The first means 51 of the control unit 50 may be adapted to map an active thread 41, 42 to a respective protocol module 31, 32 for execution with a respective dispatched event E. Each active thread 41, 42 of the corresponding number of active threads 41, 42 executes the respective protocol module 31, 32 with the respective dispatched event E1, E2 (see e.g. FIG. 2) within a defined clock cycle. Without loss of generality, the active thread 41 executes the first protocol module 31 and the active thread 42 executes the second protocol module 32.

The further embodiments of the communication device 10 of FIGS. 2 to 4, according to the present invention include the features of the communication device 10 of FIG. 1, respectively.

The second embodiment of the communication device 10 of FIG. 2 differs from the first embodiment of FIG. 1 by having a number of event queues 61, 62. Without loss of generality, the number is 2 in FIG. 2. Generally, the number could be e.g. any natural number.

With respect to FIG. 2, the control unit 50 includes first means 51, second means 52 and third means 53. The third means 53 are adapted to decide which event queue 61, 62 is to be served by the protocol modules 31-33 and the active threads 41, 42. The second means 52 are adapted to dispatch a definite number of the events E1, E2 of the served event queue, here the first event queue 61, to corresponding definite protocol modules 31, 32 in the corresponding protocol stack 20 for executing the definite protocol modules 31, 32 by corresponding number of active threads, here the active threads 41 and 42, such that the definite number of the events E1, E2 in the same protocol stack 20 are processed in parallel in a pipeline fashion. Furthermore, the number of event queues 61, 62 includes event queues 61, 62 with different priorities. For example, the first event queue 61 has a higher priority than the second event queue 62.

The third means 53 of the control unit 50 may be adapted to ensure that the first event queue 61 with the higher priority buffers no events or is empty before dispatching an event E from the second event queue 62 with a lower priority.

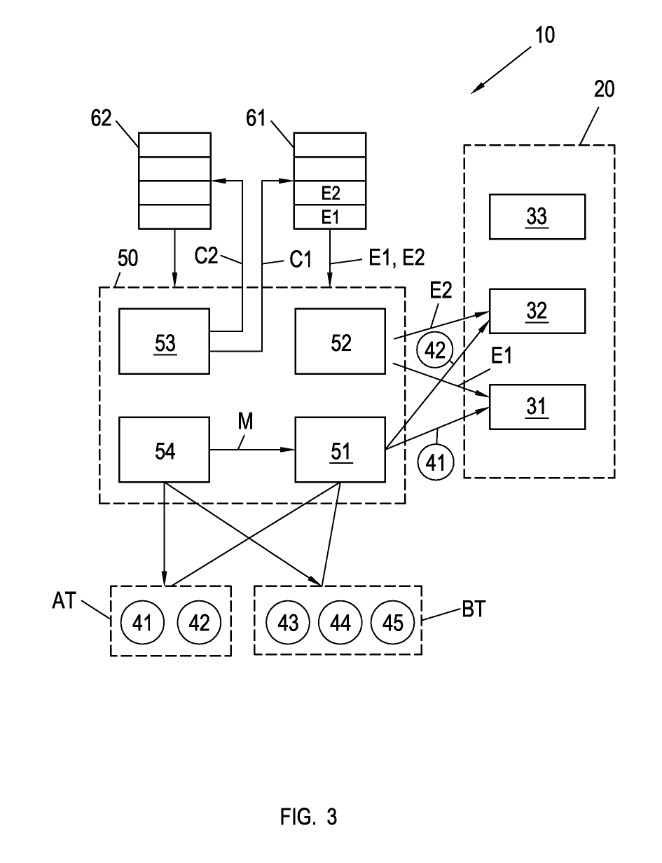

FIG. 3 shows a third embodiment of the communication device 10 of the present invention. The third embodiment is based on the second embodiment of FIG. 2 and has further fourth means 54. The fourth means 54 integrated in the control unit 50 are adapted to provide a monitoring result M after a respective monitoring duration D by monitoring the ratio R between the first time duration T1 and the second time duration T2. As a result, the first means 51 may be adapted to adjust the number of active threads 41, 42 dependent on the monitoring result M provided by the fourth means 54 after every monitoring duration D or epoch.

The monitoring duration D may be between 30 ms and 300 ms, in particular between 60 ms and 100 ms.

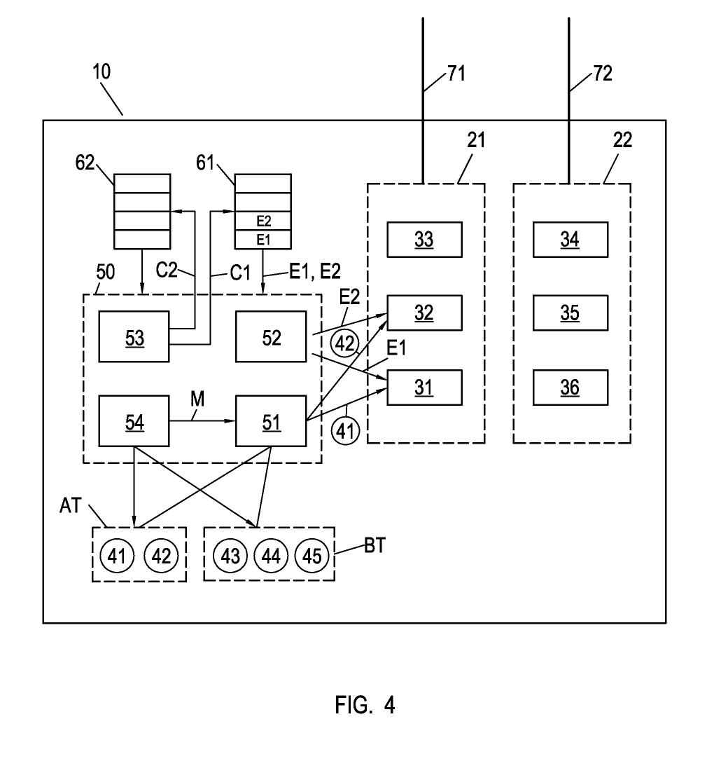

FIG. 4 shows a fourth embodiment of a communication device 10 of the present invention. The fourth embodiment is based on the third embodiment of FIG. 3 and further shows that the communication device 10 may have a plurality of protocol stacks 21, 22, each protocol stack 21, 22 is connected to a single connection 71, 73 outside the communication device 10. Without loss of generality, the communication device 10 of FIG. 4 includes two protocol stacks 21, 22 and, therefore, two single connections 71, 72.

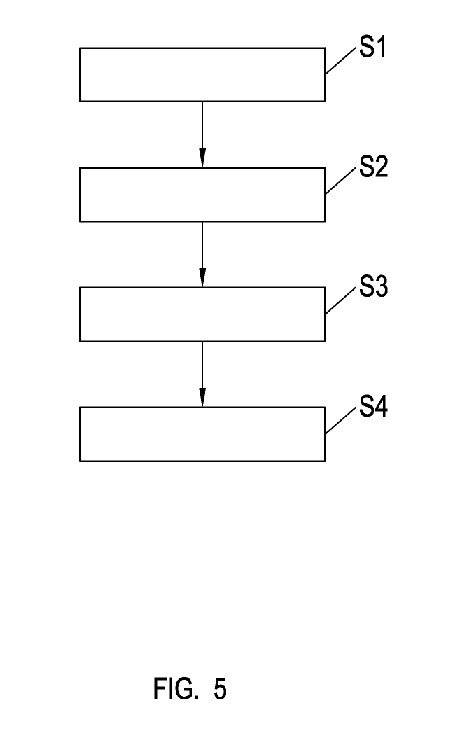

FIG. 5 is a diagram of method steps for operating a communication device 10 of the present invention. The embodiment of the method according to FIG. 5 has the following method steps S1 to S4 and is described with reference to the block diagram of FIG. 1:

Method step S1: At least one protocol stack 20 having at least two protocol modules 31-33 is provided.

Method step S2: A number of threads 41-45 for executing the protocol modules 31-33 is provided, wherein the respective thread 41-45 may be blocked or active, the respective active thread 41, 42 may be idle or busy.

Method step S3: A ratio R between a first time duration T1, wherein the active threads 41, 42 are busy, and a second time duration T2, wherein the active threads 41, 42 are idle, is monitored.

Method step S4: The number of active threads 41, 42 is adjusted dependent on the monitoring of the ratio R.

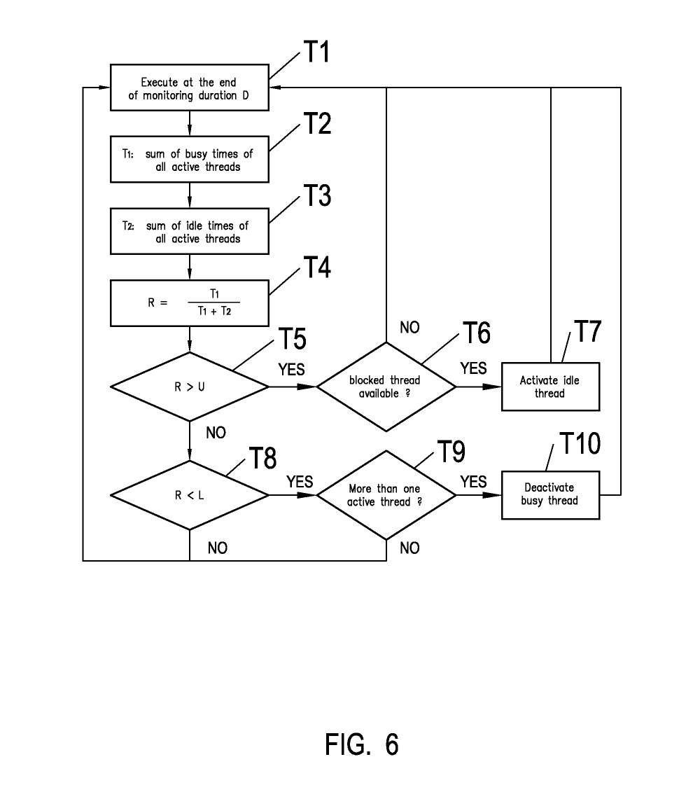

FIG. 6 shows a sequence of method steps of a second embodiment of a method for operating a communication device 10.

The second embodiment of the method according to FIG. 6 has the following method steps T1 to T10:

Method step T1: First, a communication device 10 is provided as described by the method of FIG. 5. Within a predefined monitoring duration D all active threads are monitored if they were busy or idle. Then, the method continues with method step T2.

Method step T2: The first time duration T1 is computed as a sum of busy times of all active threads.

Method step T3: In an analogous way, the second time duration T2 is computed as a sum of idle times of all active threads.

Method step T4: The ratio R between the first time duration T1 and the second time duration T2 may be computed by the following formula:

$$R = \frac{T 1}{T 1 + T 2}$$

Method step T5: Determine if the ratio R is above a predefined upper threshold U. In the positive case, the method continues with method step T6. In the negative case, the method continues with method step T8.

Method step T6: Determine if at least one blocked thread is available. In the negative case, the method continues with method step T1. In the positive case, the method continues with method step T7.

Method step T7: With respect to method step T6, at least one blocked thread is available. Then, the blocked thread is activated to be an active thread in method step T7. Then, the method can continue with method step T1 after expire of the next monitoring duration D.

Method step T8: If the ratio R is not above the predefined upper threshold U, determine if the ratio R lies under a predefined lower threshold L. In the negative case, the method continues with method step T1. In the positive case, the method continues with method step T9.

Method step T9: determine if more than one active thread exists. In the negative case, the method continues with method step T1. In the positive case, the method continues with method step T10.

Method step T10: At least one active and idle thread is deactivated to become a blocked thread.

What has been described herein is illustrative of the application of the principles of the present invention. Other arrangements and systems may be implemented by those skilled in the art without departing from the scope and spirit of this invention.

Any disclosed embodiment may be combined with one or several of the other embodiments shown and/or described. This is also possible for one or more features of the embodiments.

### ADDITIONAL EMBODIMENT DETAILS

The described techniques may be implemented as a method, apparatus or article of manufacture involving software, firmware, micro-code, hardware and/or any combination thereof. The term “article of manufacture” as used herein refers to code or logic implemented in a medium, where such medium may include hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.). Code in the computer readable medium is accessed and executed by a processor. The medium in which the code or logic is encoded may also include transmission signals propagating through space or a transmission media, such as an optical fiber, copper wire, etc. The transmission signal in which the code or logic is encoded may further include a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may include a combination of hardware and software components in which the code is embodied, processed, and executed. Of course, those skilled in the art will recognize that many modifications may be made without departing from the scope of embodiments, and that the article of manufacture may include any information bearing medium. For example, the article of manufacture includes a storage medium having stored therein instructions that when executed by a machine results in operations being performed.

Embodiments can be implemented entirely in hardware, entirely in software embodiment or in an embodiment containing both hardware and software elements. In one preferred embodiment, the present invention is implemented in software, which includes but is not limited to firmware, resident software, microcode, etc.

Certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more, but not all, embodiments unless expressly specified otherwise. The terms “including”, “including”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article. The functionality and/or the features of a device may be alternatively embodied by one or more other devices which are not explicitly described as having such functionality/features. Thus, other embodiments need not include the device itself.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

While the present invention has been described with reference to preferred embodiments, it will be understood by those of skill in the art that the above and other modifications may be made therein without departing from the spirit and scope of the invention.

What is claimed is:

1. A communication device for executing a number of threads for executing protocol modules, said communication device comprising:
at least one protocol stack having at least two protocol modules, wherein (i) the threads are blocked or active and (ii) the active threads are idle or busy; and
a control unit having first means configured to adjust the number of active threads by monitoring a ratio between a first time duration during which the active threads are busy and a second time duration during which the active threads are idle.

2. The communication device of claim 1, wherein said first means of the control unit is configured to increase the number of active threads if said ratio between said first time duration and said second time duration is above a predefined upper threshold.

3. The communication device of claim 1, wherein said first means of the control unit is configured to decrease the number of active threads if said ratio between said first time duration and the second time duration is a below a predefined lower threshold.

4. The communication device of claim 1, wherein said communication device further comprises a number of event queues, each adapted to buffer at least one event.

5. The communication device of claim 4, wherein the control unit further comprises:
second means configured to dispatch a definite number of the events of a server event queue to corresponding definite protocol modules in the corresponding protocol stack for executing the definite protocol modules by a corresponding number of active threads such that said definite number of the events within the same protocol stack may be processed in parallel in a pipeline fashion.

6. The communication device of claim 5, wherein each active thread of said corresponding number of active threads executes the corresponding protocol module with the respective dispatched event within a defined clock cycle.

7. The communication device of claim 1, wherein said control unit further comprises third means configured to decide which event queue is to be served by said protocol modules and said active threads.

8. The communication device of claim 4, wherein said number of event queues comprises event queues with differing priorities.

9. The communication device of claims 7 and 8, wherein said third means of said control unit is configured to ensure that an event queue with a higher priority buffers no event before dispatching an event from an event queue with a lower priority.

10. The communication device of claim 1, wherein said control unit further comprises fourth means configured to provide a monitoring result after a respective monitoring duration by monitoring said ratio between said first time duration and said second time duration.

11. The communication device of claim 10, wherein said first means is adapted to adjust the number of active threads dependent on said monitoring result provided by said fourth means after every monitoring duration.

12. The communication device of claim 10, wherein said monitoring duration is essentially between 30 ms and 300 ms.

13. The communication device of claim 12, wherein said monitoring duration is essentially between 60 ms and 100 ms.

14. The communication device of claim 2, wherein said upper threshold is substantially between 0.7 and 0.9.

15. The communication device of claim 3, wherein said lower threshold is substantially between 0.1 and 0.3.

16. The communication device of claim 1, wherein a dispatcher is provided, said dispatcher including said control unit and said event queue.

17. The communication device of claim 5, wherein an event has data and a header indicating a protocol module by which said event has to be processed.

18. The communication device of claim 1, wherein said communication device comprises a plurality of protocol stacks, each protocol stack being connected to a single connection outside the communication device.

19. The communication device of claim 4, wherein said corresponding protocol module is configured to generate an event and to write back said generated event to said event queue.

20. A method for operating a communication device comprising the steps of:
providing at least one protocol stack having at least two protocol modules;
providing a number of threads for executing the protocol modules, each thread being blocked or active, each active thread being idle or busy;
monitoring a ratio between a first time duration during which the active threads are busy and a second time duration during which the active threads are idle; and
adjusting the number of active threads dependent on said monitoring of said ratio.

21. A computer program product comprising a computer readable medium tangibly embodying a computer readable program, wherein the computer readable program when executed on a computer causes the computer to:
provide at least one protocol stack having at least two protocol modules;
provide a number of threads for executing the protocol modules, the respective thread being blocked or active, the respective active thread being idle or busy;
monitor a ratio between a first time duration during which the active threads are busy and a second time duration during which the active threads are idle; and
adjust the number of active threads in dependence on said monitoring of said ratio.
